(19) United States
(12) Patent Application Publication
(10) Pub. No.: US 2021/0402729 A1
(43) Pub. Date: Dec. 30, 2021

(54) CUSHIONING PACKAGE MATERIAL FOR LIQUID CRYSTAL DISPLAY AND MANUFACTURING METHOD THEREOF

(71) Applicant: Dongguan Wangquan Paper Products Co., Ltd., Guangdong (CN)

(72) Inventor: SHENG-HSI KUO, Guangdong (CN)

(73) Assignee: Dongguan Wangquan Paper Products Co., Ltd., Guangdong (CN)

(21) Appl. No.: 16/986,189

(22) Filed: Aug. 5, 2020

(30) Foreign Application Priority Data
Jun. 28, 2020 (CN) 202021216714.3

(51) Int. Cl. B31D 5/00; B65D 85/30; B65D 81/05

(52) U.S. Cl. CPC B31D 5/0069; B65D 81/053; B65D 85/307

(57) ABSTRACT

A cushioning package material for liquid crystal display includes two cushioning members. The two cushioning members are fixedly connected to form an L-shaped structure and each cushioning member includes a U-shaped tubular portion and a cuboid tubular portion.

### CROSS-REFERENCE TO RELATED APPLICATION

This application claims the priority to China Patent Application No. 202021216714.3, filed on Jun. 28, 2020. The entirety of the above-mentioned patent application is hereby incorporated by reference herein and made a part of this specification.

### BACKGROUND

### Technical Field

This application relates to a field of a package material, and more particularly, to a cushioning package material for liquid crystal display and a manufacturing method thereof.

### Description of Related Art

A liquid crystal display is a common electronic product in daily life, mainly including a display panel and a backlight which is located at a raised structure on the back of the liquid crystal display.

A package cushioning material is required for the liquid crystal display during transportation. There are a variety of package materials available on the market, which includes a foamed material obtained from EVA foaming and a foam plastic processed from polystyrene. For example, a Chinese utility model patent No. CN205661852U and a Chinese utility model patent No. CN205661851U disclose package materials made of plastic. Although the liquid crystal display can be well transported by using these package materials, package materials are generally difficult to be degraded, for which it will cause long-term irreversible damage to the environment if they are not well recycled.

The package material made of paper is also a type of cushioning package material commonly used in the field of the package. A green cushioning package device for a finished product of the liquid crystal display, disclosed by a Chinese utility model patent No. CN201506573U that has a package material made of paper. However, such package material of the display is obviously designed for the liquid crystal display with a specific shape, which cannot be commonly used, and it is difficult to achieve automatic production, which requires a large number of operators to fold and assemble individual components, resulting in relatively high cost for this cushioning package material.

### SUMMARY

In light of the problems present in the prior art, this application provides a cushioning package material for liquid crystal display which is recyclable, environmentally friendly, commonly used, and easy for automatic production.

A cushioning package material for liquid crystal display, made of paper, includes two cushioning members, wherein the two cushioning members are fixedly connected to form an L-shaped structure and each of the cushioning members includes a U-shaped tubular portion and a cuboid tubular portion.

By adopting the above technical solution, the liquid crystal display can be well packaged in this application. One cushioning package material with the L-shaped structure can protect one corner of the liquid crystal display and four cushioning package materials can package four corners of the liquid crystal display, in which the U-shaped tubular portion is used for receiving the display panel of the liquid crystal display and the cuboid tubular portion is used for protecting the backlight of the liquid crystal display.

Preferably, a paper tube having an oval cross-section is disposed inside the cuboid tubular portion.

By adopting the above technical solution, the oval paper tube can improve the cushioning effect of the cuboid tubular portion, making the cuboid tubular portion better resistant to impact or bumps.

Preferably, there are a plurality of paper tubes.

The proper number of remainders of paper tubes with different lengths which are prone to be produced by the paper production manufacturer during the production process of cutting paper tubes are selected and filled into the cuboid tubular portion of the product of this application, which can be used to improve the cushioning effect of the cuboid tubular portion, in such a way that it is advantageous for the utilization of waste remainders and it is unnecessary to produce paper tube specialized for filling the product of the application.

Preferably, the two cushioning members are in integral connection via a connecting cardboard and joints of the two cushioning members are attached by environmentally friendly adhesive paper.

By adopting the above technical solution, the two cushioning members are firmly connected together integrally by the connecting cardboard. The environmentally friendly adhesive paper itself is environmentally friendly, thus the use of environmentally friendly adhesive paper bonding accords with the concept of modern environmental protection.

Preferably, the connecting cardboard comprises a main body portion and four covering portions, a fold is disposed at a middle part of the main body portion, and the four covering portions are all disposed at long sides of the main body portion and are integrally formed together with the main body portion.

By adopting the above technical solution, the main body portion of the connecting cardboard is firstly bonded to the two cushioning members, then two covering portions cover two sides of one cushioning member, the other two covering portions cover two sides of the other cushioning member, and the main body portion is folded along the fold disposed at the middle of the main body portion to obtain the L-shaped cushioning package material for liquid crystal display.

Preferably, a thickened cardboard is disposed at one side of the cuboid tubular portion away from the U-shaped tubular portion.

By adopting the above technical solution, the thickened cardboard can improve the cushioning effect.

Preferably, the thickened cardboard is a corrugated cardboard.

By adopting the above technical solution, the corrugated cardboard has a good cushioning effect, which is suitable for being used as the thickened cardboard.

Preferably, a strengthening insertion tube is disposed inside the U-shaped tubular portion.

By adopting the above technical solution, the strengthening insertion tube can improve the structural stability of the U-shaped tubular portion.

In summary, this application includes at least one of the following beneficial effects.

(1) The product of this application is recyclable and environmentally friendly, which accords with the concept of modern environmental protection.

(2) The product of this application is safe and stable, providing a good cushioning effect.

(3) The product of this application facilitates mechanized production, which has low production cost.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an overall structure of Embodiment 1;

FIG. 2 is a schematic diagram of an unfolded structure of a connecting cardboard of Embodiment 1;

FIG. 3 is a manufacturing process diagram of a cushioning member of Embodiment 1;

FIG. 4 is an overall manufacturing process diagram of Embodiment 1;

FIG. 5 is a side view of a cuboid tubular portion of Embodiment 2;

FIG. 6 is a side view of a cuboid tubular portion of Embodiment 3; and

FIG. 7 is a schematic diagram of an unfolded structure of a connecting cardboard in Embodiment 7.

### DESCRIPTION OF THE EMBODIMENTS

This application is described in detail below in combination with the drawings and embodiments.

The same components are provided with the same reference signs.

### Embodiment 1

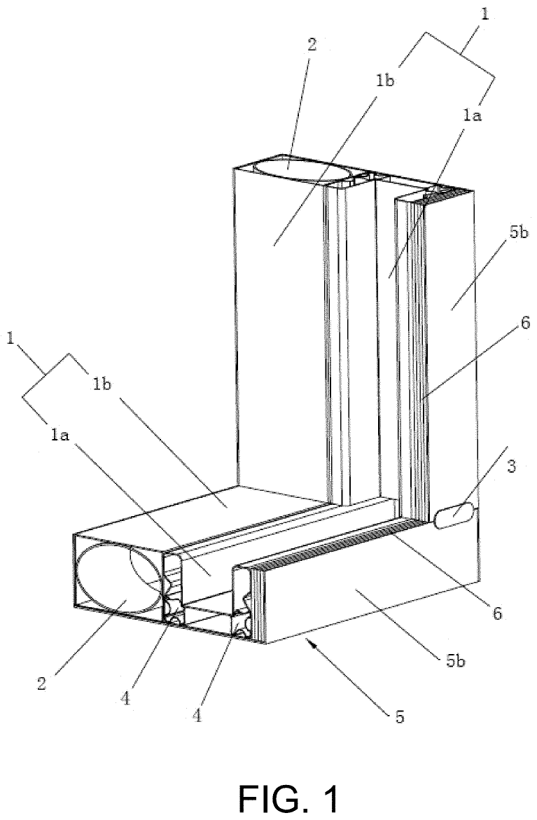

Referring to FIG. 1, a cushioning package material for liquid crystal display is made of paper, including two cushioning members. In this embodiment, the two cushioning members have same size and shape. The two cushioning members 1 are fixedly connected to form an L-shaped structure, and each of the cushioning members 1 includes a U-shaped tubular portion 1a and a cuboid tubular portion 1b. A plurality of paper tubes 2 having oval cross-section are disposed inside the cuboid tubular portion 1b. The two cushioning members 1 are in integral connection via a connecting cardboard 5, and joints between the two cushioning members 1 are connected by environmentally friendly adhesive paper 3. A thickened cardboard 6 is disposed at one side of the cuboid tubular portion 1b away from the U-shaped tubular portion 1a. The thickened cardboard 6 is a corrugated cardboard. A strengthening insertion tube 4 is disposed inside the U-shaped tubular portion 1a.

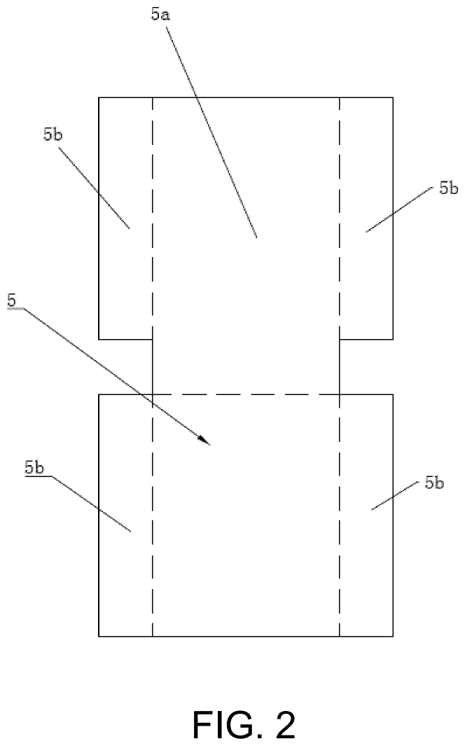

Referring to FIG. 1 and FIG. 2, the connecting cardboard 5 includes a main body portion 5a and four covering portions 5b. A fold is disposed at a middle part of the main body portion 5a, and the four covering portions 5b are all disposed at long sides of the main body portion 5a and are integrally formed together with the main body portion 5a. The length of the main body portion 5a is equal to the sum of the height of the cushioning member 1 and twice the length of the cushioning member 1, and the width of the main body portion 5a is equal to that of the cushioning member 1. The width of the covering portion 5b is equal to the height of the cushioning member 1, and the length of the covering portion 5b is equal to that of the cushioning member 1.

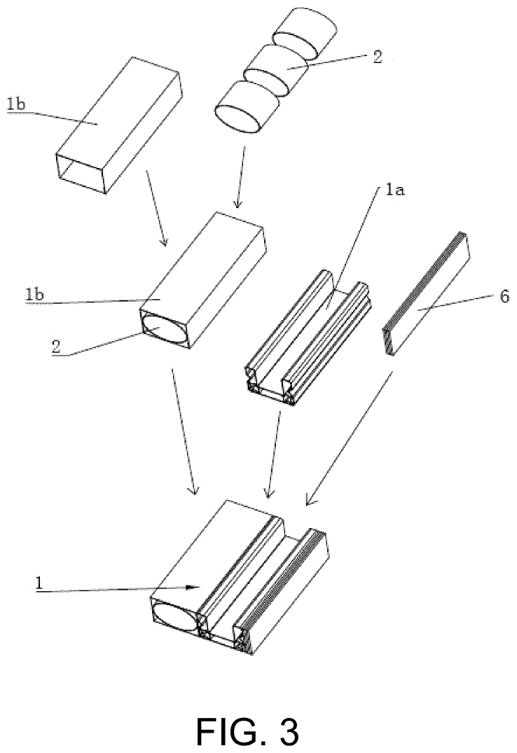

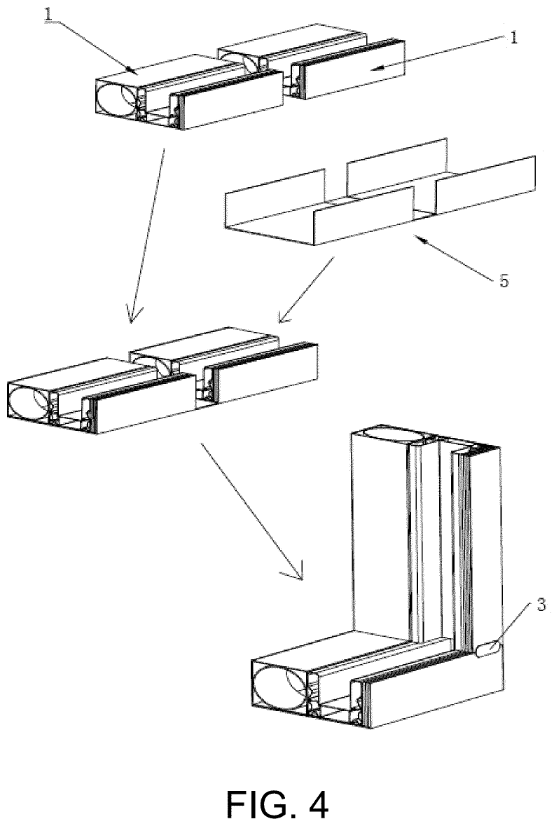

Referring to FIG. 3 and FIG. 4, a manufacturing method for the cushioning package material for liquid crystal display of this embodiment includes the following steps:

S1, inserting a plurality of paper tubes 2 into the cuboid tubular portion 1b;

S2, bonding the cuboid tubular portion 1b, the U-shaped tubular paper 1a, and the thickened cardboard 6 to form the cushioning member 1;

S3, bonding the two cushioning members 1 and one connecting cardboard 5 and folding up to form a semi-finished product of the cushioning package material for liquid crystal display; and

S4, folding the semi-finished product of the cushioning package material for liquid crystal display into an L shape and then attaching the joints of the two cushioning members 1 by the environmentally friendly adhesive paper 3.

Embodiments 2-8 can be understood in combination with FIG. 1-FIG. 7.

### Embodiment 2

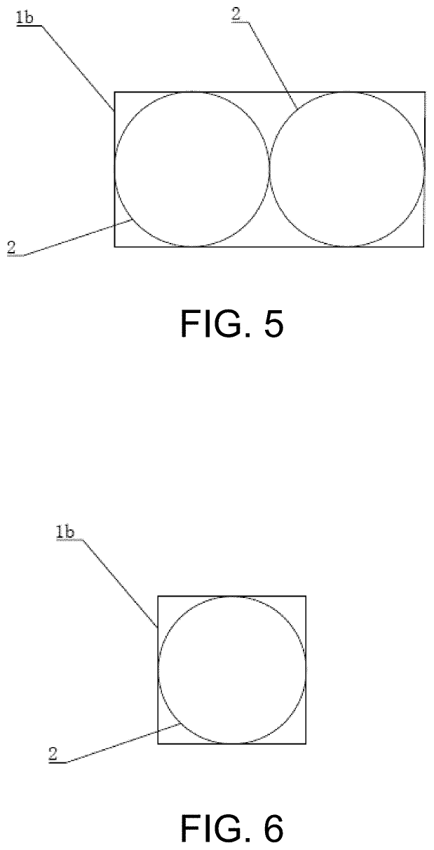

Referring to FIG. 5, the overall shape and structure of this embodiment differ from those of Embodiment 1 in that a row of two cylindrical paper tubes 2 are disposed inside the cuboid tubular portion 1b in this embodiment.

### Embodiment 3

Referring to FIG. 6, the overall shape and structure of this embodiment differ from those of Embodiment 1 in that the cross section of the cuboid tubular portion 1b is square and the cross section of the paper tube 2 is circular.

### Embodiment 4

The overall shape and structure of this embodiment differ from those of Embodiment 1 in that only one paper tube 2 is disposed inside the cuboid tubular portion 1b in this embodiment.

### Embodiment 5

The overall shape and structure of this embodiment differ from those of Embodiment 1 in that, the two cushioning members 1 are fixedly connected via an adhesive, instead of the connecting cardboard 5, so as to form the L-shaped structure in this embodiment.

### Embodiment 6

The overall shape and structure of this embodiment differ from those of Embodiment 1 in that, in this embodiment, the sizes of the two cushioning members 1 are different, in which the length of one cushioning member 1 is shorter than that of the other one. It should also be noted that those skilled in the art can appropriately adjust the size of the cushioning member 1 according to actual needs for the package, and such adjustments should be considered as proposed under the technical motivation of this application, which falls within the scope of this application.

### Embodiment 7

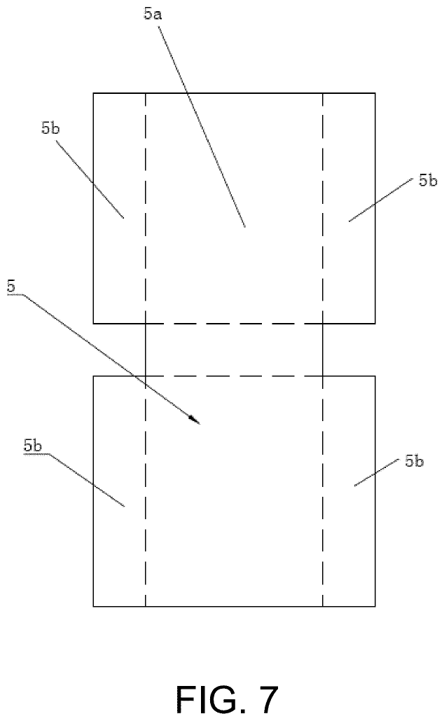

Referring to FIG. 7, the overall shape and structure of this embodiment differ from those of Embodiment 1 in that, in this embodiment, two folds are disposed in the middle of the connecting cardboard 5. When the automatic production line is busy with producing and processing, it might be impossible to conduct automatic production for every liquid crystal display packaging material. This embodiment can facilitate the folding operation for the operator, so that the operator can finish the folding step without finding the direction.

### Embodiment 8

The overall shape and structure of this embodiment differ from those of Embodiment 1 in that the U-shaped tubular portion 1a is not provided with the strengthening insertion tube 4 in this embodiment.

What is provided above is merely some preferred embodiments of this application. The scope of this application is not limited by the above embodiments, but should include all technical solutions under the thinking of this application. It is to be noted that, some improvements and modifications can be made by those skilled in the art without departing from the principle of this application, and should be considered to fall within the scope of this application.

What is claimed is:

1. A cushioning package material for liquid crystal display made of a paper material, the cushioning package material for liquid crystal display comprising two cushioning members, wherein the two cushioning members are fixedly connected to form an L-shaped structure and each of the cushioning members comprises a U-shaped tubular portion and a cuboid tubular portion.

2. The cushioning package material for liquid crystal display according to claim 1, wherein a paper tube having an oval cross-section is disposed inside the cuboid tubular portion.

3. The cushioning package material for liquid crystal display according to claim 2, wherein the paper tube is plural in number.

4. The cushioning package material for liquid crystal display according to claim 1, wherein the two cushioning members are in integral connection via a connecting cardboard and joints of the two cushioning members are connected by environmentally friendly adhesive paper.

5. The cushioning package material for liquid crystal display according to claim 4, wherein the two cushioning members are of the same size and shape.

6. The cushioning package material for liquid crystal display according to claim 4, wherein the connecting cardboard comprises a main body portion and four covering portions, at least one fold is disposed at a middle part of the main body portion, and the four covering portions are all disposed at long sides of the main body portion and are integrally formed together with the main body portion.

7. The cushioning package material for liquid crystal display according to claim 1, wherein a thickened cardboard is disposed at one side of the cuboid tubular portion away from the U-shaped tubular portion.

8. The cushioning package material for liquid crystal display according to claim 7, wherein the thickened cardboard is a corrugated cardboard.

9. The cushioning package material for liquid crystal display according to claim 1, wherein a strengthening insertion tube is disposed inside the U-shaped tubular portion.

10. A manufacturing method for a cushioning package material for liquid crystal display comprising the following steps:
S1, inserting a plurality of paper tubes into a cuboid tubular portion;
S2, bonding the cuboid tubular portion, a U-shaped tubular paper and a thickened cardboard to form a cushioning member;
S3, bonding two cushioning members and one connecting cardboard, and folding up to form a semi-finished product of the cushioning package material for liquid crystal display; and
S4, folding the semi-finished product of the cushioning package material for liquid crystal display into an L shape, and then attaching joints of the two cushioning members via environmentally friendly adhesive paper.
